(19) United States
(12) Patent Application Publication
(10) Pub. No.: US 2006/0085478 A1
(43) Pub. Date: Apr. 20, 2006

(54) Third-party automated tracking, analysis, and distribution of registry status information

(76) Inventors: Michael Landau, Greenbrae, CA (US); Evan Horowitz, San Francisco, CA (US)

Correspondence Address: PERKINS COIE LLP, P.O. BOX 2168, MENLO PARK, CA, 94026, US

(21) Appl. No.: 10/968,833

(22) Filed: Oct. 18, 2004

(51) Int. Cl. G06F 17/00

(52) U.S. Cl. 707/104.1

(57) ABSTRACT

The present invention contemplates a variety of improved techniques including A system, method, and computer program product are provided for optimized third-party tracking and distribution of status information for a plurality of disparate registries. Initially, the invention is configured to automatically track status information for multiple registry databases. At certain intervals, the invention queries a registry database for updates to specific status requests. The invention then analyzes the returned information from the registry and updates/archives the information as necessary. Other entities or systems that desire this updated status information can then be notified about any changes in an efficient manner.

### BACKGROUND OF INVENTION

1. Field of Invention

The present invention relates to multiple registry status management, and more particularly to providing automated timely and efficient distribution of such information.

2. Description of Related Art

One of the most useful aspects of the Internet is the instant access to information it provides. Beyond access to simple static information such as reference information, online databases routinely provide constantly updated information on all aspects of everyday life. Among other applications, real-time online databases are now used to check bank balances, track orders and shipments, track stock prices, track legal proceedings, and check a physician or contractor's license. Whereas tracking or acknowledging the status of something like a college application in the recent past required phone or postal correspondence with the college, today the applicant can simply login online to stay updated on application status. This type of efficient exchange of dynamic information is constantly expanding as technology develops.

Web Notification/Update Services

Web-based and wireless notification services are an important complement to the Internet and come in a number of varieties. The basic principle behind all of these time saving services is to automatically notify an individual based on some triggering event. The triggering event then initiates a communication (email, sms/wireless, fax, or otherwise) to the individual with information about the event.

For example, web site services exist that will notify an individual by email any time a web site of the individual's choosing is updated with new or different content. Such services sometimes also exist “built-in” to the individual's network browser such as Microsoft Internet Explorer or Netscape Navigator. On a very basic level, these services operate by taking a “snap-shot” of the web-site to monitor, and compare that original snap-shot to new snap-shots taken at future intervals. If the snap-shots do not match each other based on certain criteria, the individual is notified.

A Single Registry Example—Domain Status Tracking

Internet services also exist to notify an individual of a change in status at one particular registry location or within an extremely narrow range of related registries. For example, a number of Internet domain registrars will track and monitor domain names from a central international registry and alert an individual if a particular domain name changes status. These services are typically used by individuals to make sure their domains are not misappropriated by hackers, or are used to legitimately re-acquire domain names that have been deleted from the central registry.

The narrow reach of these status-monitoring systems is evident when one considers the “status clearinghouse” model of the present invention. This is illustrated further below.

### SUMMARY OF THE INVENTION

According to the invention, a third-party service provider tracks, analyzes, and reports status information from a plurality of separate registries. The invention is initially configured, and subsequently re-configured, to determine “how and where” to track various registry status information over a computer network. Additionally, the invention is configured as to what to track, analyze, and interpret from the various registries.

Subsequently, the invention queries the various registries based on the existing configuration. The returned information from the registries is then analyzed with respect to any previous status information the invention had previously archived. The invention may also relationally analyze the returned data to determine common elements within the information.

Finally, the status clearinghouse invention timely updates and notifies any interested entities as determined by the existing configuration. As such, the invention provides an efficient and optimized interface to monitor disparate registry information.

The invention may be a method in one embodiment. The method may include obtaining changes in a set of one or more intellectual property (IP) registries. The method may also include updating an IP docketing database with data responsive to obtaining changes. The method may further include interfacing with a user for access to the IP docketing database. The method may also include populating the IP docketing database with information related to a set of IP assets. The method may include additional aspects in various embodiments.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. The drawings should thus be regarded as exemplary rather than limiting. In the drawings:

FIG. 1 is a suitable embodiment of the invention.

FIG. 2 is an example of web data-scraping.

FIG. 3 is an example of an embodiment of a method of providing information from registries to a docketing database.

FIG. 4 is an example of an embodiment of a network which may be used with the present invention.

FIG. 5 is an example of a computer which may be used with the present invention.

### DETAILED DESCRIPTION OF THE INVENTION

### Multiple Disparate Registries—Patents and Trademarks

Intellectual property rights, including patents and trademarks, are cornerstones of the U.S. legal system. And with the increasing importance of digital and biological technology, and a growing world economy, intellectual property rights will continue to gain importance. For many reasons, however, the process of acquiring a patent or trademark is a process that can require more than a year, and some times many more.

With the advent of the Internet, it is now possible to track patent and trademark applications during the “pending” process through the official United States Patent and Trademark Office at http://www.uspto.gov. While the USPTO normally corresponds with applicants or attorneys via U.S. mail, and more recently via email, the status of a patent or trademark may change without formal notification. For example, when a new patent application is assigned to an examiner, formal notification may not occur. However, this change in status may be something that the applicant or attorney would like to be made aware of. As such, the new online databases provide much more information than would previously be available through normal correspondence.

While online access is a significant improvement, the slow process would require a diligent user to search the USPTO repeatedly for updated information over a very long period of time. Needless to say, a system that automatically notifies interested parties between formal notifications is desirable. Very recently, the European Patent Office has implemented such a system at http://www.epoline.org. Similarly, there are a number of services that alert a subscriber to the actual issuance or publication of a patent or trademark, but these services do not track the status of pending applications.

The present invention improves the range and functionality of such online registry status databases and services by adding the technology and resources of a third-party service provider that specializes in notification management products and services, as described below. In addition, the clearinghouse nature of information from multiple registries allows for relational elements to be developed. For example, a company may own patents, trademarks, copyrights, domain names and licensing rights as intellectual property such that the relational status clearinghouse can provide a “portfolio” of registry status information from separate and unrelated registries.

Benefits of Third-Party Services

Although a registry may provide its own notification services, there are many drawbacks for the registry (and end-users alike) to a service provided exclusively by the registry. Many of these short comings can be solved with a third-party system, as described below. Since the third-party specializes in such services, a variety of value-added features become possible:

User and Email Management:

a) sophisticated user management such as account “preferences.”

b) encrypted environment for privacy and security.

c) multiple-recipient capability so that more than just the “official” correspondent can track the registry status.

Data Aggregation From Multiple Sources:

a) ability to aggregate status tracking from multiple related or non-related registries, such as patents and trademarks, in one interface.

b) ability to aggregate status tracking from multiple sources or jurisdictions, such as the U.S. and Europe, in one interface.

Specialized Technology and Services:

a) efficient use of public resources via optimized database query structuring that reduces duplicative/redundant queries.

b) very timely notification of status changes based on optimized structured queries that learn when/how the registry status database typically updates.

c) multi-functional graphical user interface and toolbar for user-friendly and efficient use/management.

d) data integration with other commercial products and services.

e) relational analysis of information from separate registries to determine possible common elements.

Direct Database Access vs. Web Data-Scraping

Third-party party services as described above, and including this invention, rely on either direct access to registry data or data collected thru “data-scraping.” There are advantages and disadvantages to both methods as described below.

Direct access refers to accessing the registry database information directly through an interface provided by, or with the approval of, the registry itself. In most cases this means that the data collector and the registry have an official relationship, commercial or otherwise, such that there is cooperation or an understanding between the parties.

However, data-scraping (also known as screen-scraping) does not require an official relationship between the parties, in that the data collector can query information using a publicly accessible web site mechanism to obtain similar information as through direct access to data. To avoid causing a burden on registry services, automated data-scrapers are optimized and use best practices in following a standard known as the Robots Exclusion Protocol. Data-scrapers can also be configured to run at prescribed intervals to avoid accessing the database at busy times (i.e. data-scrape at night), or when status information is unlikely to have been updated (i.e. on weekends).

The most significant advantage of data-scraping is that it does not require any initial setup or integration with the registry, and in fact the registry may not even be aware it is being data-scraped if the data-scraper is efficient and polite. In this way it is an ex parte mechanism. If the data-scraper is not polite and causes disruption in the normal service of the registry to the general public, the registry might possibly block the data-scraper from accessing any further registry information through various limited-access means.

Besides from possible limited access to the registry database, data-scrapers must also be concerned with changes in the formatted output of data from the registry, in that the data-scraper relies on many pre-determined patterns within the data. In this case, since the registry has no affiliation with the data-scraper, the registry does not know to alert the data-scarper about changes in output. Therefore, the data-scraper must be vigilant of output changes and/or develop sophisticated parsing algorithms to minimize format dependence.

Since the current invention depends on querying multiple registries, the optimum solution is a hybrid that combines a mix of direct access to registry information when available and/or practical, while resorting to data-scraping if direct access is impractical or impossible. As an extreme, yet familiar, example of data-scraping, most search engines that rely on “spidering” technology are fundamentally large benign data-scrapers. In addition, the auto-sensing functionality contained in CouponToolbar relies heavily on data-scraping.

It should also be noted that commercial data scraping software exists that will aggregate disparate information if desired, but it has inherent limitations even if it can be reconfigured. Specifically, the mechanisms required to “fine-tune” the data-scraper to overcome subtle access mechanisms put in place by the registry are not available in commercial software. As a result, commercial software configured for such a task is clumsy, inefficient, and extremely limited in value-added functionality, in comparison to the present invention.

A suitable embodiment of the invention may be found at: http://www.ipalert.com

Other types of suitable registries for tracking with the present invention include immigration status databases, legal case status databases, medical and pharmaceutical status databases, and many others that will apparent to those skilled in the art.

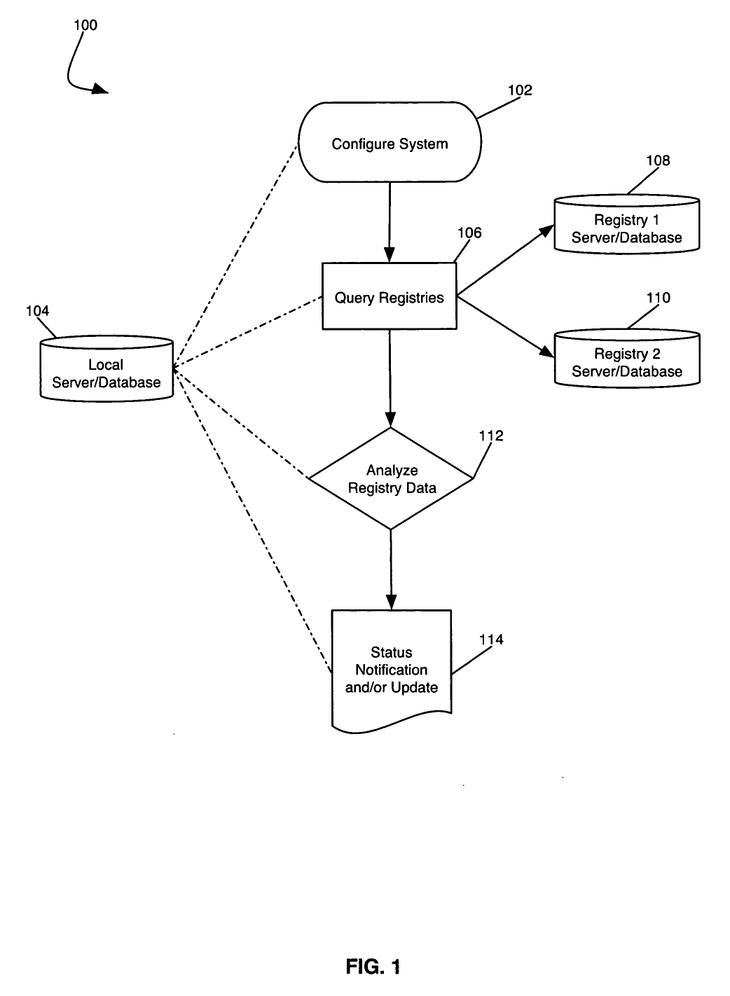

FIG. 1 depicts a suitable embodiment of the present invention, 100. At 102, the invention is configured for multiple registry tracking. Configuration typically includes providing the invention with sufficient information to determine a) what registries to track, b) how to locate registry status information, c) what information to track within the registry, and d) how to interpret registry status information. Configuration information is typically saved on a local server and/or in a database, 104. Other types and methods of configuration will be apparent to those skilled in the art.

At 106, the invention requests specific information from the various registries, as determined previously in any configuration, 102, as saved in 104. In this figure, the queries are directed at registry databases 108 and 110, although any plurality of registry databases is possible. As described above, the queries/requests for status information are typically made via direct access to the registry, or some method of data-scraping of the registry, 200. Any necessary parsing for extraction of specific data is also performed in this step, as described further below.

Next at 112, the returned data is analyzed and interpreted to determine if status has been updated or changed. This analysis may be as simple as looking at the value of a “Last Updated” date, or looking at the value of a single variable that denotes status, or as complicated as determining a sequence of events from raw data, or detecting sophisticated changes in status based on multiple variables. Typically, this analysis is made with respect to archived data from previous queries at 104.

Finally at 114, any updates or notifications are initiated as previously configured at 104. Typically this involves communicating the updated information to an entity through an email, fax, instant message, etc., or by updating a web-based user interface to be accessed by the entity.

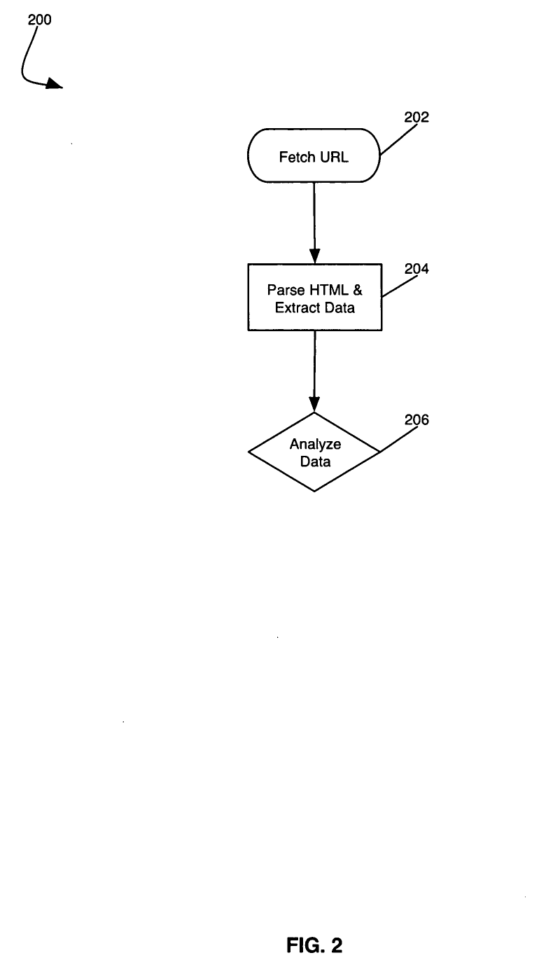

FIG. 2 illustrates the components of a typical web data-scraping operation, 200. At 202, the data-scraping mechanism fetches the content of a URL over a computer network. This mechanism is very similar to a network web browser requesting the URL, in that the returned information is normally HTML or text data to be parsed at step 204. Whereas a network browser's main function is to format the fetched/returned data in a browser window, the main function of 202 is to simply acquire the raw data.

At 204, the raw data from the previous operation is parsed for the desired information. In most cases this means separating the important data from the superfluous extraneous data that is not needed, analogous to “separating the wheat from the chaff.” In this operation, the concept of pattern-matching is fundamental to successful parsing. As will be apparent to those skilled in the art, pattern-matching allows the successful extraction of pieces of information from raw data based on common features or “patterns” in similar data.

After the data is parsed at 204, the extracted data is analyzed at 206. Typically, analysis occurs by comparing the new data to previously-scraped data that has been archived. The scraped-data is typically added to the previously-archived data to create an ongoing history of data.

The process of 200 can be illustrated by the following real-world application for data-scraping the official registry status of an individual trademark application:

First at 202, the data-scraper requests the data contained in the web trademark database for a particular trademark application. The returned data is then parsed at 204 to extract the information from within the HTML document that indicates the current status of the trademark application. The newly extracted status information is then analyzed at 206 to determine if it differs from the status returned from the last data-scraping operation. Other applications of data-scraping will be apparent to those skilled in the art.

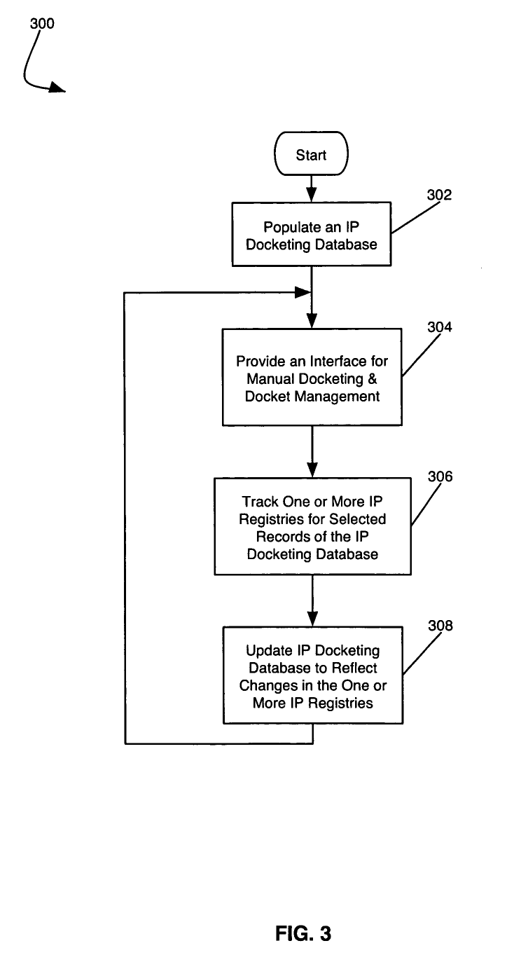

Data-scraping can be used as a data source for many different types of systems. FIG. 3 is an example of an embodiment of a method of providing information from registries to a docketing database. FIG. 3 represents an embodiment of a method, and also represents operations of a system or apparatus embodying the present invention. The method and all methods of this application includes a set of modules which may be implemented in a variety of ways, including implementations which reorder or reorganize such modules, and including implementations in which modules are used in a parallel fashion.

Process 300 includes populating a docketing database, interfacing with the database for manual data management, tracking related information in IP registries, and updating data in the database responsive to changes in the IP registries. At 302, an intellectual property docketing database (IP database) is populated with information related to intellectual property (IP assets). Such information may include biographical information such as inventor names, author names, assignors and assignees; such information may also include status information such as serial numbers or identification numbers for applications, registration numbers for issued or granted intellectual property rights, and other information related to IP assets.

At 304, a user interface is provided allowing for manual manipulation or viewing of information in the database. This may include entering information or updating information from a user or client, or viewing status information for an IP asset. Such a user interface may take on a variety of forms depending on types of users and software chosen.

At 306, IP registries (intellectual property registry interfaces) are checked for changes in records related to IP assets of the IP database. This may be done based on recorded preferences of a user, or based on rules incorporated in related software determining which registry interfaces should be accessed. Checking for changes may include checking for any change, checking for selected changes (such as user-selected events from a set of potential events), or checking for a set of predetermined changes (such as a set of potential events included in software).

At 308, the IP database is updated based on any changes found at 306. Thus, changes in status of applications or granted IP assets may be reflected in the IP database responsive to detection of those changes at 306. Changes in the IP database allow for user viewing of such changes, and can be used as trigger events to alert a user to changes related to IP assets. Frequency of checking of changes can be either set by a user or predetermined, allowing for infrequent monitoring when no changes are expected and frequent monitoring when changes are expected (or desired).

Other aspects of process 300 may include alerting the user in the user interface based on changes detected, generating email alerts responsive to changes detected, setting preferences for how alerts should be generated and for events for which alerts should be generated, and other user interface options. Moreover, process 300 may include a module related to alerting third parties (other than a user) to changes or events, such as sending an email to a client on behalf of an attorney, or to an attorney on behalf of a client for example. Additionally, process 300 may further include generation of templates populated with information specific to an IP asset, such as responses to Office Actions of a Patent Office or Trademark Office, or cover letters for payments of maintenance fees or annuities for example.

Systems and Networks

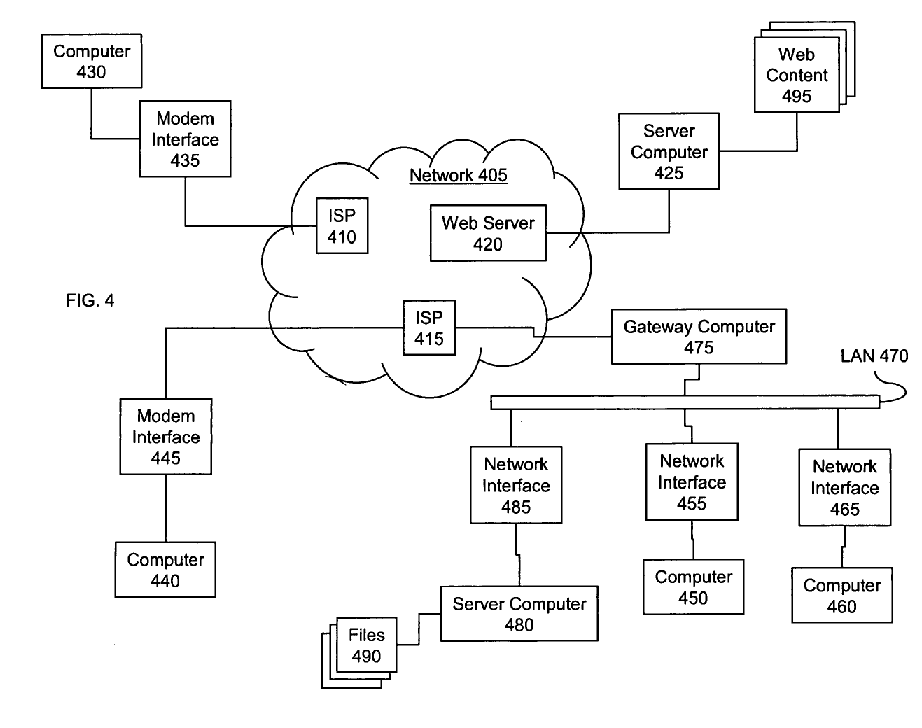

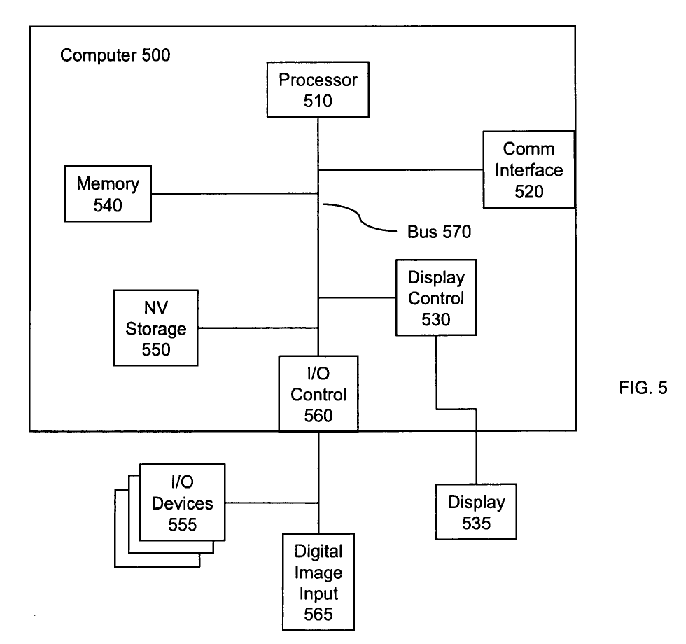

The following description of FIGS. 4-5 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 4 shows several computer systems that are coupled together through a network 405, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 405 is typically provided by Internet service providers (ISP), such as the ISPs 410 and 415. Users on client systems, such as client computer systems 430, 440, 450, and 460 obtain access to the Internet through the Internet service providers, such as ISPs 410 and 415. Access to the Internet allows users of the client computer systems to exchange information, receive and send e-mails, and view documents, such as documents which have been prepared in the HTML format. These documents are often provided by web servers, such as web server 420 which is considered to be “on” the Internet. Often these web servers are provided by the ISPs, such as ISP 410, although a computer system can be set up and connected to the Internet without that system also being an ISP.

The web server 420 is typically at least one computer system which operates as a server computer system and is configured to operate with the protocols of the World Wide Web and is coupled to the Internet. Optionally, the web server 420 can be part of an ISP which provides access to the Internet for client systems. The web server 420 is shown coupled to the server computer system 425 which itself is coupled to web content 495, which can be considered a form of a media database. While two computer systems 420 and 425 are shown in FIG. 4, the web server system 420 and the server computer system 425 can be one computer system having different software components providing the web server functionality and the server functionality provided by the server computer system 425 which will be described further below.

Client computer systems 430, 440, 450, and 460 can each, with the appropriate web browsing software, view HTML pages provided by the web server 420. The ISP 410 provides Internet connectivity to the client computer system 430 through the modem interface 435 which can be considered part of the client computer system 430. The client computer system can be a personal computer system, a network computer, a Web TV system, or other such computer system.

Similarly, the ISP 415 provides Internet connectivity for client systems 440, 450, and 460, although as shown in FIG. 4, the connections are not the same for these three computer systems. Client computer system 440 is coupled through a modem interface 445 while client computer systems 450 and 460 are part of a LAN. While FIG. 4 shows the interfaces 435 and 445 as generically as a “modem,” each of these interfaces can be an analog modem, ISDN modem, cable modem, satellite transmission interface (e.g. “Direct PC”), or other interfaces for coupling a computer system to other computer systems.

Client computer systems 450 and 460 are coupled to a LAN 470 through network interfaces 455 and 465, which can be Ethernet network or other network interfaces. The LAN 470 is also coupled to a gateway computer system 475 which can provide firewall and other Internet related services for the local area network. This gateway computer system 475 is coupled to the ISP 415 to provide Internet connectivity to the client computer systems 450 and 460. The gateway computer system 475 can be a conventional server computer system. Also, the web server system 420 can be a conventional server computer system.

Alternatively, a server computer system 480 can be directly coupled to the LAN 470 through a network interface 485 to provide files 490 and other services to the clients 450, 460, without the need to connect to the Internet through the gateway system 475.

FIG. 5 shows one example of a conventional computer system that can be used as a client computer system or a server computer system or as a web server system. Such a computer system can be used to perform many of the functions of an Internet service provider, such as ISP 410. The computer system 500 interfaces to external systems through the modem or network interface 520. It will be appreciated that the modem or network interface 520 can be considered to be part of the computer system 500. This interface 520 can be an analog modem, ISDN modem, cable modem, token ring interface, satellite transmission interface (e.g. “Direct PC”), or other interfaces for coupling a computer system to other computer systems.

The computer system 500 includes a processor 510, which can be a conventional microprocessor such as an Intel Pentium microprocessor or Motorola Power PC microprocessor. Memory 540 is coupled to the processor 510 by a bus 570. Memory 540 can be dynamic random access memory (DRAM) and can also include static RAM (SRAM). The bus 570 couples the processor 510 to the memory 540, also to non-volatile storage 550, to display controller 530, and to the input/output (I/O) controller 560.

The display controller 530 controls in the conventional manner a display on a display device 535 which can be a cathode ray tube (CRT) or liquid crystal display (LCD). The input/output devices 555 can include a keyboard, disk drives, printers, a scanner, and other input and output devices, including a mouse or other pointing device. The display controller 530 and the I/O controller 560 can be implemented with conventional well known technology. A digital image input device 565 can be a digital camera which is coupled to an I/O controller 560 in order to allow images from the digital camera to be input into the computer system 500.

The non-volatile storage 550 is often a magnetic hard disk, an optical disk, or another form of storage for large amounts of data. Some of this data is often written, by a direct memory access process, into memory 540 during execution of software in the computer system 500. One of skill in the art will immediately recognize that the terms “machine-readable medium” or “computer-readable medium” includes any type of storage device that is accessible by the processor 510 and also encompasses a carrier wave that encodes a data signal.

The computer system 500 is one example of many possible computer systems which have different architectures. For example, personal computers based on an Intel microprocessor often have multiple buses, one of which can be an input/output (1/0) bus for the peripherals and one that directly connects the processor 510 and the memory 540 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 540 for execution by the processor 510. A Web TV system, which is known in the art, is also considered to be a computer system according to the present invention, but it may lack some of the features shown in FIG. 5, such as certain input or output devices. A typical computer system will usually include at least a processor, memory, and a bus coupling the memory to the processor.

In addition, the computer system 500 is controlled by operating system software which includes a file management system, such as a disk operating system, which is part of the operating system software. One example of an operating system software with its associated file management system software is the family of operating systems known as Windows® from Microsoft Corporation of Redmond, Washington, and their associated file management systems. Another example of an operating system software with its associated file management system software is the LINUX operating system and its associated file management system. The file management system is typically stored in the non-volatile storage 550 and causes the processor 510 to execute the various acts required by the operating system to input and output data and to store data in memory, including storing files on the non-volatile storage 550.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored or embodied in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

We claim:

1. A method for third-party tracking and distribution of status information for a plurality of disparate registries, comprising:
configuring automated optimized tracking of the registry information databases,
querying the registries for updated status information;
analyzing and archiving the status information returned by the registries;
effectively notifying an entity of such changes in an optimized manner.

2. A method as recited in claim 1, further comprising:
a graphical user interface and/or browser toolbar to manage configuration.

3. A method as recited in claim 1, further comprising:
automated interaction with legal software to distribute status information to attorneys for case/docket management.

4. A method as recited in claim 1, further comprising:
a relational analysis of registry status information from separate registries to determine common elements.

5. A system for providing third-party tracking and distribution of status information for a plurality of disparate registries, comprising:
means for configuring automated optimized tracking of the registry information databases;
means for querying the registries for updated status information;
means for analyzing and archiving the status information returned by the registries;
means for effectively notifying an entity of such changes in an optimized manner.

6. A system as recited in claim 5, further comprising:
means for a graphical user interface and/or browser toolbar to manage configuration.

7. A system as recited in claim 5, further comprising:
means for automated interaction with legal software to distribute status information to attorneys for case/docket management.

8. A system as recited in claim 5, further comprising:
means for a relational analysis of registry status information from separate registries to determine common elements.

9. A computer program embodied on a computer readable medium for third-party tracking and distribution of status information for a plurality of disparate registries, comprising:
a code segment for configuring automated optimized tracking of the registry information databases;
a code segment for querying the registries for updated status information;
a code segment for analyzing and archiving the status information returned by the registries;
a code segment for effectively notifying an entity of such changes in an optimized manner.

10. A computer program as recited in claim 9, further comprising:
a code segment for a graphical user interface and/or browser toolbar to manage configuration.

11. A computer program as recited in claim 9, further comprising:
a code segment for automated interaction with legal software to distribute status information to attorneys for case/docket management.

12. A computer program as recited in claim 9, further comprising:
a code segment for a relational analysis of registry status information from separate registries to determine common elements.

13. A method, comprising:
obtaining changes in a set of one or more intellectual property (IP) registries; and
updating an IP docketing database with data responsive to obtaining changes.

14. A method as recited in claim 13, further comprising:
interfacing with a user for access to the IP docketing database.

15. A method as recited in claim 14, further comprising:
populating the IP docketing database with information related to a set of IP assets.

16. A method as recited in claim 13, further comprising:
alerting a user to a change obtained from the set of one or more IP registries.

17. A method as recited in claim 14, further comprising:
repeating the obtaining and updating at a predetermined frequency.

18. A method as recited in claim 13, further comprising:
generating a template with IP asset specific information responsive to a change obtained from an IP registry of the set of one or more IP registries.

19. A method as recited in claim 13, further comprising:
alerting a third-party to a change obtained from the set of one or more IP registries.

20. A method as recited in claim 13, further comprising:
interfacing with a user for access to the IP docketing database;
populating the IP docketing database with information related to a set of IP assets;
repeating the obtaining and updating at a predetermined frequency;
generating a template with IP asset specific information responsive to a change obtained from an IP registry of the set of one or more IP registries; and
alerting a user to a change obtained from the set of one or more IP registries.

21. A method as recited in claim 13, wherein:
the method is embodied in a machine-readable medium as a set of instructions which, when executed by a processor, cause the processor to perform the method.
